(19) United States
(12) Patent Application Publication
(10) Pub. No.: US 2006/0283973 A1
(43) Pub. Date: Dec. 21, 2006

(54) Energy saving shower head

(76) Inventor: John H. Bean JR., Wentzville, MO (US)

Correspondence Address: Wilson Daniel Swayze, Jr, 3804 Clearwater Ct, Plano, TX, 75025, US

(21) Appl. No.: 11/148,524

(22) Filed: Jun. 9, 2005

(51) Int. Cl. A01G 27/00

(52) U.S. Cl. 239/70; 239/69; 239/71; 239/548; 239/75; 239/72

(57) ABSTRACT

A shower head for controlling the flow of water to a user includes an inlet for allowing the water to enter the shower head, a microcontroller to control the time duration of the flow of the water, and a valve to shut off the water after said time duration.

### FIELD OF THE INVENTION

The present invention relates to a shower apparatus and in particular shower heads.

### BACKGROUND OF THE INVENTION

Energy consumption in family domiciles is an important issue both domestically and abroad. One significant factor of energy consumption is the heating of water for personal hygiene with personal showers being one of the most common uses of the hot water. Typically, showers are taken on a daily basis by each individual of society. Conventional shower heads can consume up to 3 gallons per minute or more, and tap water is delivered at approximately 55° Fahrenheit and may be heated up to 115° F. for shower use. If a family of three reduces their use of the shower 4 minutes each, this can result in annual savings of $154.00 or more per year.

Unrestricted, some family members may take excessively long showers. This results in the potential for even greater savings if these long showers could be eliminated or shortened. Savings in energy costs can be achieved by controlling the amount of heated water that is wasted while taking a shower. Additional savings can be achieved in terms of reducing the amount of water also. The above savings can be extended to commercial applications including hotels, motels, multi-family rental units and fitness centers and in any other type of establishment that include shower facilities.

### SUMMARY OF THE INVENTION

The present invention saves energy by controlling automatically the amount of water including hot water by controlling the water flow rate and the duration of the water flow. The shower head is self powered by generating electrical energy from the moving water. An icon based user interface includes security features to allow only an authorized user of the shower head to select the time durations that best fit the needs of the individual family members. These time durations can be activated when the water temperature reaches a predetermined water temperature. Additionally, the shower head of the present invention detects unsafe water temperatures and provides an alarm when the unsafe water temperatures are reached. The shower head of the present invention performs system diagnostics that detect valve failure and automatically opens the valve after such a valve failure. The present invention allows the flow rate to be measured and to maintain a constant flow rate based upon the measured flow rate.

The shower head of the present invention includes electronics powered by a power supply, and a flow control valve that is controlled by a user interface and that is adjustable for adjustment of shower duration. The flow control valve has a reset time interval to reset the shower duration for the next shower. The shower of the present invention is self-contained, generating its own electricity from the flow of the water through the shower head. The shower head of the present invention monitors the temperature of the water passing through the shower head and provides an alert if the water temperature exceeds a potentially unsafe level. Additionally, the shower head of the present invention will pre-positioned the valve to the open position in the event of detected failures. The shower head of the present invention delays starting the predetermined timing until the water temperature reaches a predetermined level. The shower head of the present invention regulates the water flow by adjustment of the flow control valve.

### BRIEF DESCRIPTION OF THE DRAWINGS

FIG. 1 illustrates a cross-sectional view of the shower head of the present invention;

FIG. 2 illustrates an end view of the shower head;

FIG. 3 illustrates a perspective view of the motor assembly;

FIG. 4 illustrates an exploded view of the motor and plunger of the present invention

FIG. 5 illustrates a side view of the shower head of the present invention;

FIG. 6 illustrates an exploded view of the plunger of the present invention;

FIG. 7 illustrates a perspective view of the slinger of the present invention;

FIG. 8 illustrates an exploded view of the spray head and valve of the present invention;

FIG. 9 illustrates a perspective view of the motor and plunger;

FIG. 10 illustrates a view of the user interface of the present invention.

FIG. 11 illustrates another view of the user interface of the present invention;

FIG. 12 illustrates a battery charging circuit for the present invention;

FIG. 13 illustrates a flow chart showing the steps of the processing of the microprocessor;

FIG. 14 illustrates a flow chart of the flow rate control;

FIG. 15 illustrates a power supply circuit for the shower head motor;

FIG. 16 illustrates a driver circuit for driving a motor of the present invention;

FIG. 17 illustrates an interface circuitry for interfacing with a user;

FIG. 18 illustrates control circuitry including a micro controller.

### DETAILED DESCRIPTION

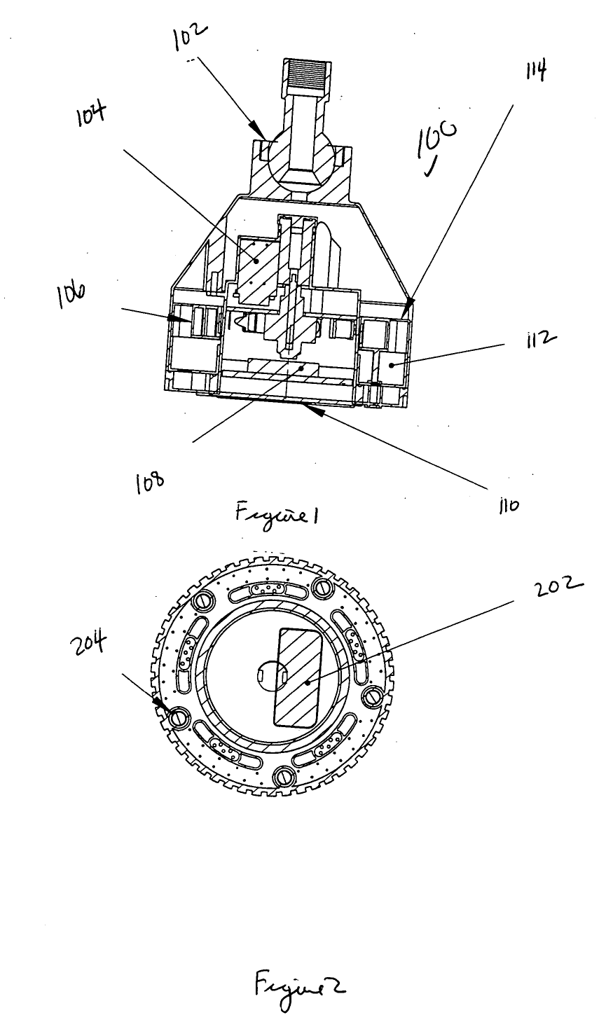

FIG. 1 illustrates a cross-sectional side view of the shower head 100 of the present invention. As shown in FIG. 1, the shower head 100 includes a pivot ball 102 to allow the shower head 100 to be moved in various directions by the user, an inlet to connect to a water source to input water to the shower head 100 and a circuit board feedback circuit 104 to provide feedback to the microcontroller 1805 for temperature variations in the water temperature. The shower head 100 additionally includes a slinger assembly 106 to be rotated by the flow of the water and to generate electricity from the rotation of the slinger assembly 106. The element 108 is a rechargeable battery. A spray head 110 allows the user to adjust the spray pattern, including the possibility of a pulsation “message”. A path 112 for water to flow from the slinger 106 to the spray head 110 is shown in FIG. 1. A partition 114 between the motor/slinger assemblies and the plunger assemblies is shown.

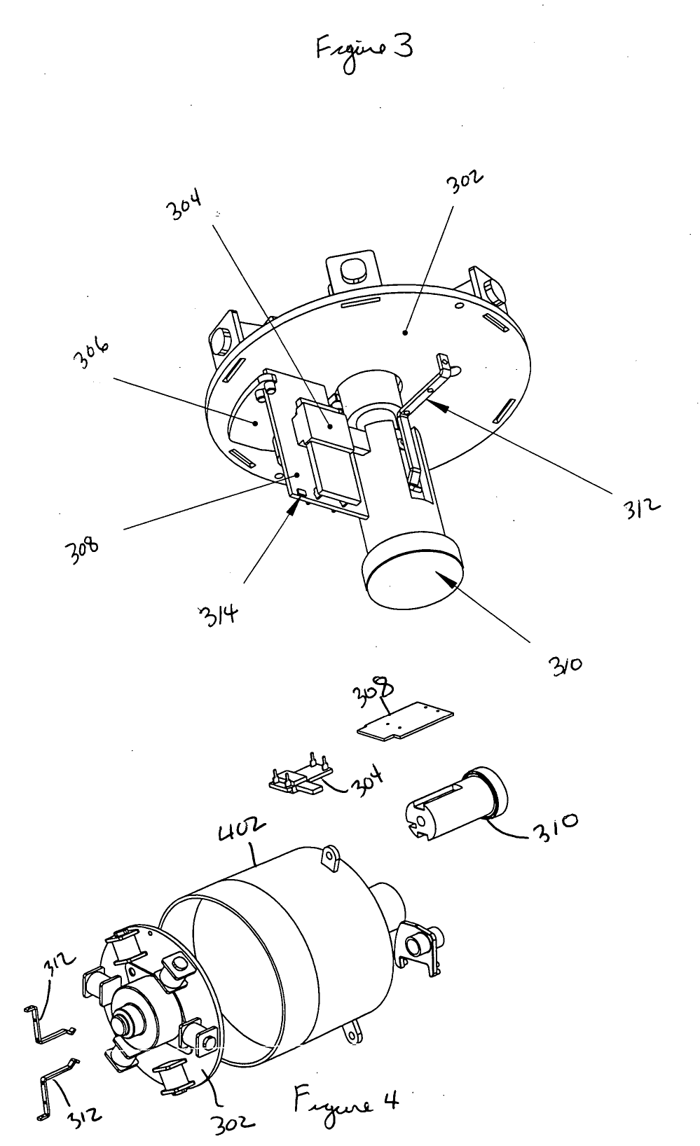

FIG. 2 illustrates a cross-sectional view of the spray head 110. More particularly, positioned around the outer perimeter of a spray head 110 is a valve assembly 204 for controlling the flow of the water out of the spray head 110 of the shower head 100. FIG. 2 illustrates a user interface 202 to allow the user to change the operating characteristics of the shower head 100.

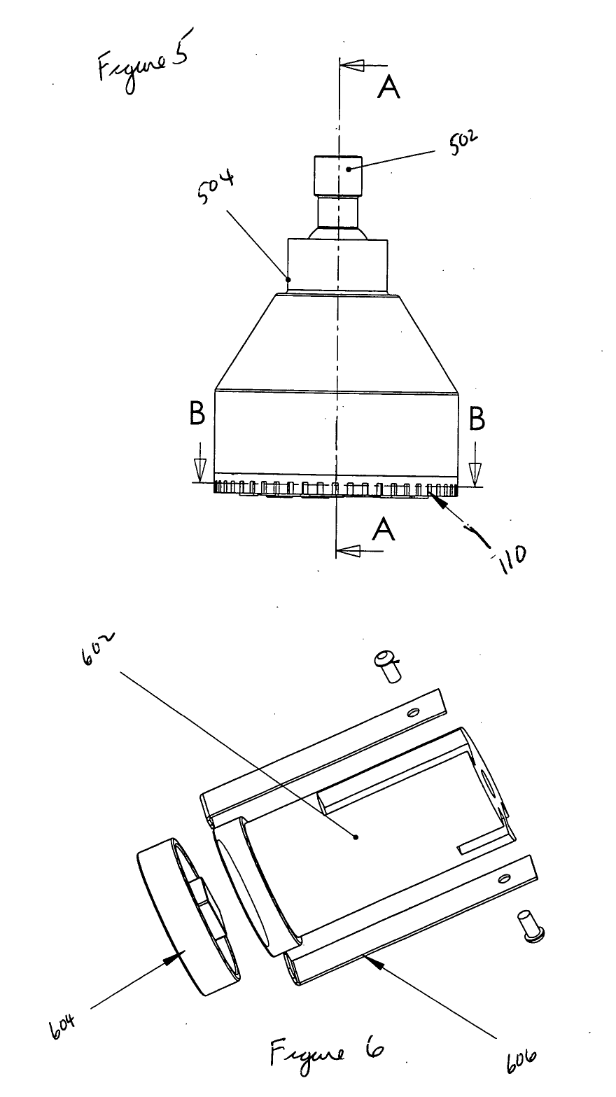

FIG. 3 illustrates a perspective view of the plunger assembly 310 of the present invention. The plunger assembly 310 is mounted on the reverse side of the motor/generator assembly 302. The plunger assembly 310 includes a brush plunger contact 312 to provide electrical contact for the plunger assembly 310. A clamp 306 for sensor feedback circuit board 308 is mounted on the motor assembly 302, and a circuit board feedback sensor 308 is mounted along the plunger assembly 310. A thermistor 314 is mounted on the circuit board feedback sensor 308 to measure the temperature of the water flowing through the shower head 100. The plunger assembly 310 adjusts the flow of the water to the shower head 100, and the plunger assembly 310 is powered from the generator and/or the battery.

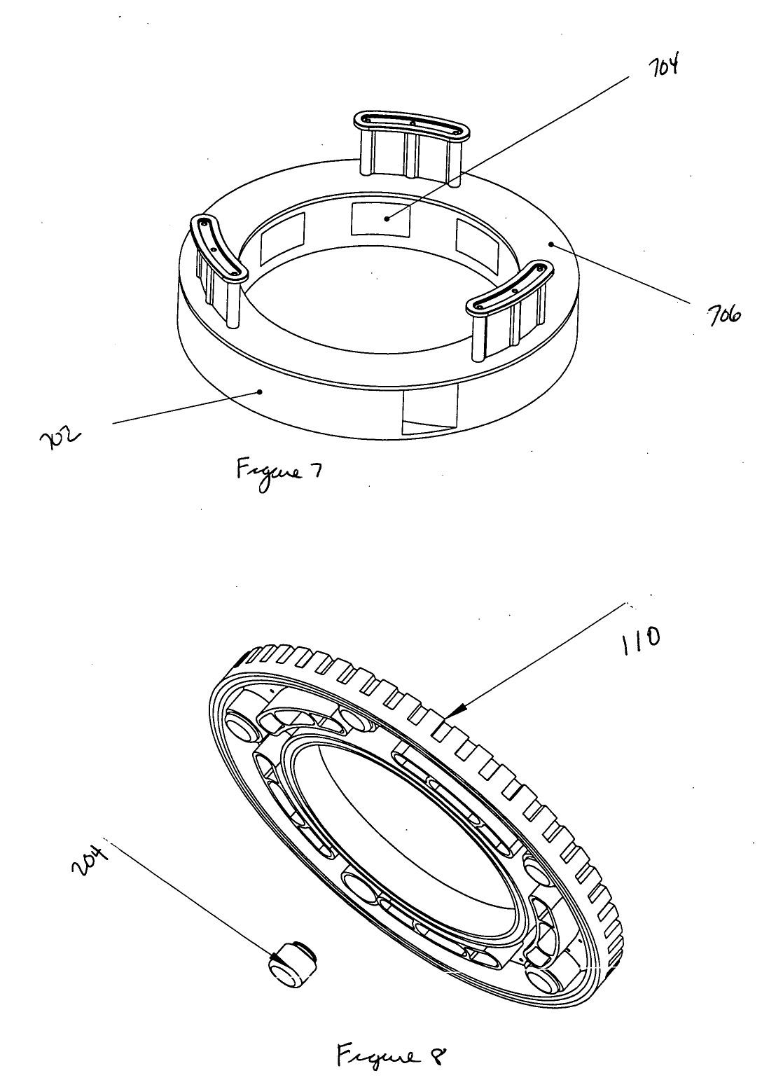

FIG. 4 illustrates an exploded view of the motor/generator assembly and the plunger assembly. In addition to the parts already described, FIG. 4 shows a motor shell 402 to provide a water tight housing for the motor.

FIG. 5 illustrates a side view of the shower head 100 of the present invention. FIG. 5 shows a pivot ball assembly 502 to allow the shower head 100 to be pivoted so that the user can position the shower head 100 to a desired position. FIG. 5 additionally shows an outer shell 504 to protect the inner electronics and connect to the spray head 110. The outer shell 504 also serves as the outer surface of the water flow channel.

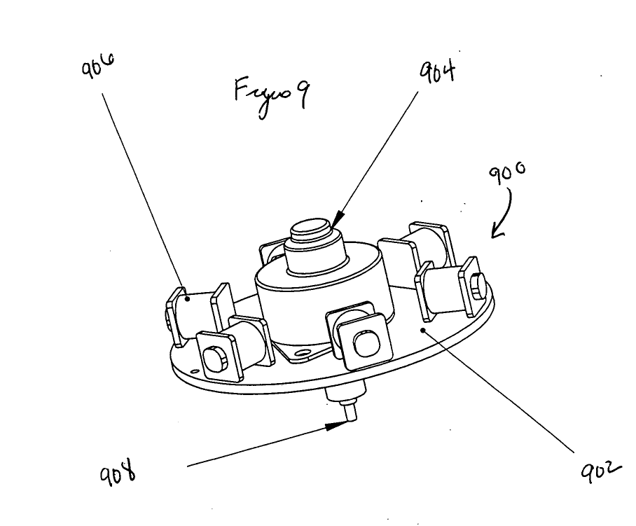

FIG. 6 illustrates an exploded view of the inner plunger assembly 602 with associated plunger contact 606 and plunger face 604. The plunger face 604 provides the electrical contacts necessary to short the brush contacts 606 when water pressure is exerted against the plunge face 604.

FIG. 7 illustrates the slinger apparatus 702 which includes magnets 704 being spaced around the inner circumference of the slinger apparatus 702. Inductors (not shown) are spaced on the inside of the slinger apparatus 702 including a slinger cap 706 to act as a generator to generate electricity from the moving magnets 704. This electricity is used to power the internal circuitry of the shower head 100. Additionally, a backup battery (not shown) is placed on the inside of the circumference of the slinger apparatus 702.

FIG. 8 shows a perspective view of the spray head 110. Additionally, FIG. 8 shows the valve assembly 204 which controls the flow of water from the spray head 110.

FIG. 9 illustrates a perspective view of the motor/generator 900 of the present invention. The motor 900 includes inductor(s) 906 to generate electricity which is used by the shower head 100 for the control circuits including the microcontroller 1805 and for storing electricity in the battery (not shown). The motor assembly 904 includes the battery and magnets for interacting with the inductors 906. FIG. 9 also shows an actuator shaft 908 to drive the plunger 310.

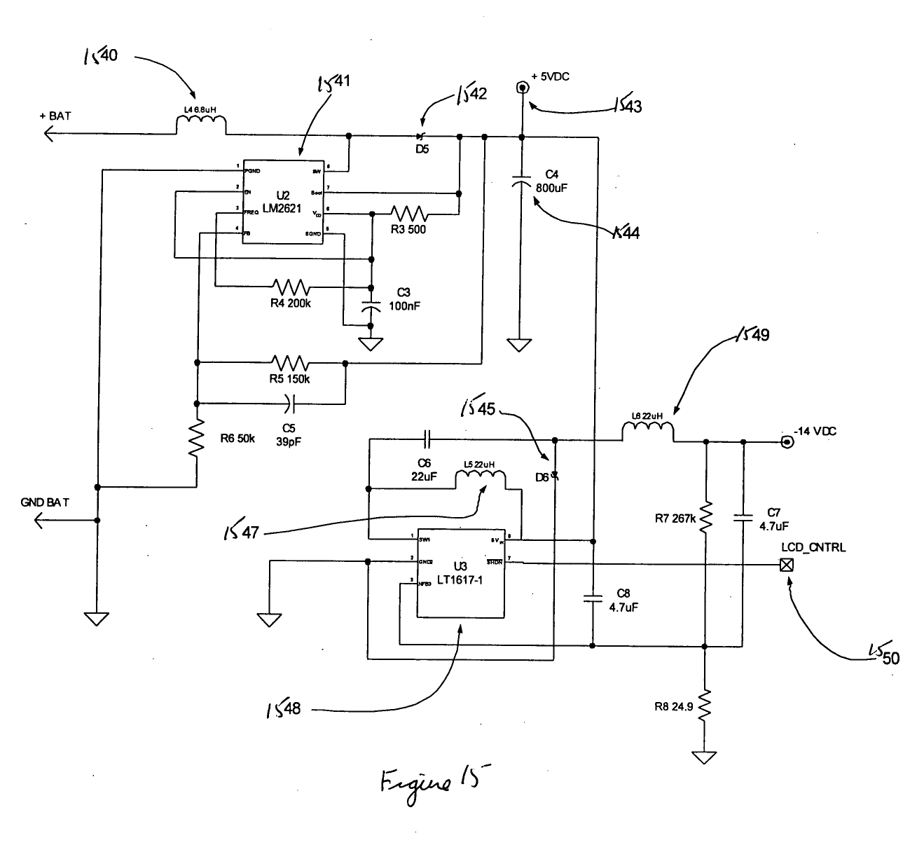

FIG. 13 shows the shower event time control by showing the steps that the microcontroller 1805 executes. At step 1305, the micro controller 1805 starts processing, and in step 310, interrupts are monitored. In step 315, it is determined if an interrupt has been detected. If there has been no interrupt, control passes back to step 1310. If there has been an interrupt, then the micro controller 1805 enters the run mode to monitor the water temperature. In step 1325, the micro controller 1805 determines if the actual water temperature equals the setting for the water temperature. If the water does equal the setting, then the duration timer is reset and the duration timer is started in step 1330. The micro controller 1805 monitors the duration timer in step 1330. In step 1335, the micro controller 1805 determines if the duration timer has tripped; if yes, then the battery is tested in step 1367. In step 1369, the battery test will be evaluated to determine if a suitable charge exists to allow the operation of the flow control valve motor for both an open and close cycle, if the battery is good, then control passes to step 1370 which closes the flow control valve, resets the off timer and starts the off timer. This shuts off the showerhead.

Next, if the manual water valve is not shut off, an audible alarm is sounded along with a visual flashing display. In step 1374 where the presence or absence of water pressure against valve face will be evaluated, the micro controller 1805 determines if the manual valve to the water supply is shut off. If the manual valve is not shut off, the audible alarm and the visual flash display is activated by the micro controller 1805 in step 1375. Control then passes to step 1374. If the manual valve has been shut off, the manual off timer is monitored in step 1378. If the off timer has not tripped, then control returns to step 1378. Step 1380 determines if the off timer has tripped. If the off timer has tripped, control passes to step 1390. In step 1390, if the spray valve is closed, the flow control valve is opened and the micro controller 1805 enters the sleep mode, ending at step 1395 and monitoring the interrupts at step 1310.

Returning to step 1335, if the duration timer has not tripped, then, the micro controller 1805 determines if water is flowing in step 1340. If water is flowing, then control passes to step 1330. If water is not flowing, in step 1340, the duration timer is stopped, the wait timer is reset and the wait timer is started. Control passes to step 1350, and the wait timer is monitored by the micro controller 1805. In step 1355, the micro controller 1805 tests to see if the wait timer has tripped. If the wait timer has not tripped, then control passes to step 1360 to determine if the water is flowing through the shower head 100. If no water is flowing through the showerhead, then control passes to step 1350. If water is flowing then control passes to step 1365 where the wait timer is reset and the duration timer is started. Control now passes to step 1330.

If the wait timer has tripped in step 1355, and control passes to step 1357 where the micro controller 1805 enters the sleep mode. In step 1395, the processing ends, and the micro controller 1805 monitors the interrupts at step 1310.

FIG. 14 shows the flow rate control by the micro controller 1805. The system through the micro controller 1805 will operate the motorized flow control valve 204 in incremental steps opening or to closing as needed to maintain the desired rate of flow of water. The voltage output from the alternator is proportional to the speed of the slinger and water flow rate. In step 1405, the micro controller 1805 monitors the output of the alternator by acquiring the value of the analog-to-digital conversion register. In step 1415, this value acquired is measured against an upper limit threshold in this example 7V, and if the value acquired is greater than 7 V, the wheel is rotating excessively fast due to excess water flow. In step 1420, the flow control valve 204 is closed only one step. In this way, the flow control valve 204 does not change too much. If the voltage acquired is less then 7 V, then control passes to decision block 1425. Should be alternator output be less than 5 V in this example, the slinger is rotating too slowly, and there is insufficient water flow. In step 1425, if the acquired voltage is less than five volts, then control passes to step 1430 where the flow control valve is opened one step. Next, control returns to step 1405 to begin the cycle again. If the acquired voltage is greater than 5 V, then the shower head 100 is operating within limits, and control returns to step 1405 where the cycle begins again. Assuming that the output of the alternator voltage is between the upper or lower limits, in this example between 7V and 5V, the sequence of steps will be repeated for the duration of the shower without opening and closing the valves. However, incremental opening and closing of the valves in steps will be taken to maintain nominal water flow.

As illustrated in FIG. 2, a user interface 202 is shown on the bottom of the showerhead. This interface 202 provides visual and audible prompts reflecting the operating state of the shower head 100 and allowing the user to modify variables by use of a tactile membrane key pad or other suitable types of pushbuttons. The interface 202 includes a LCD which is backlit by discrete lighting for example two discrete LCD lights. The LED 1023 which may be green shows the normal operating state of the showerhead, and LED 1021 which may be red provides an indication that 80% or greater of the predetermined amount of water has been consumed. This LED 1021 provides indication that the water is close to being shut off and that the user should take appropriate steps to finish the shower. Additionally, an audible device 1022 will intermittently beep when the 90 percent of the completion threshold of the shower duration is reached. Furthermore, the audible device 1022 will beep when any of the pushbuttons are depressed by the user.

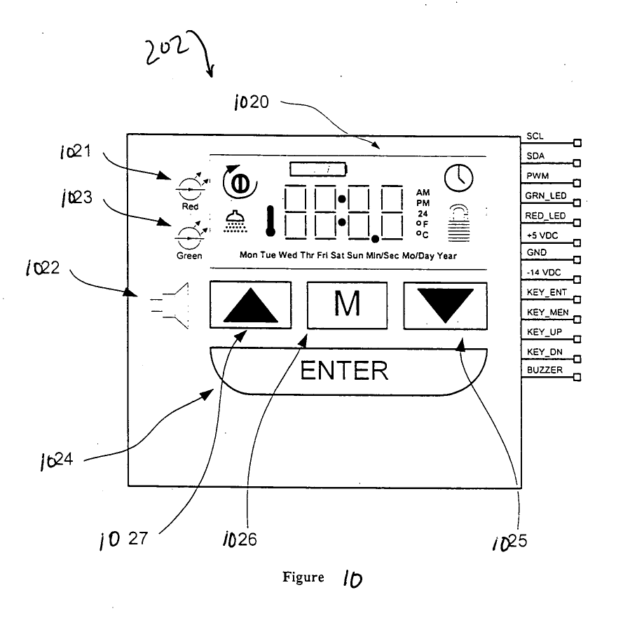

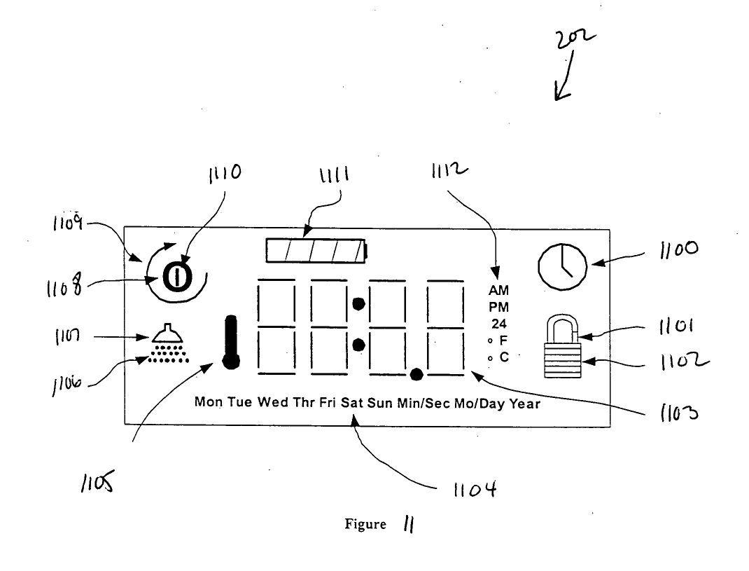

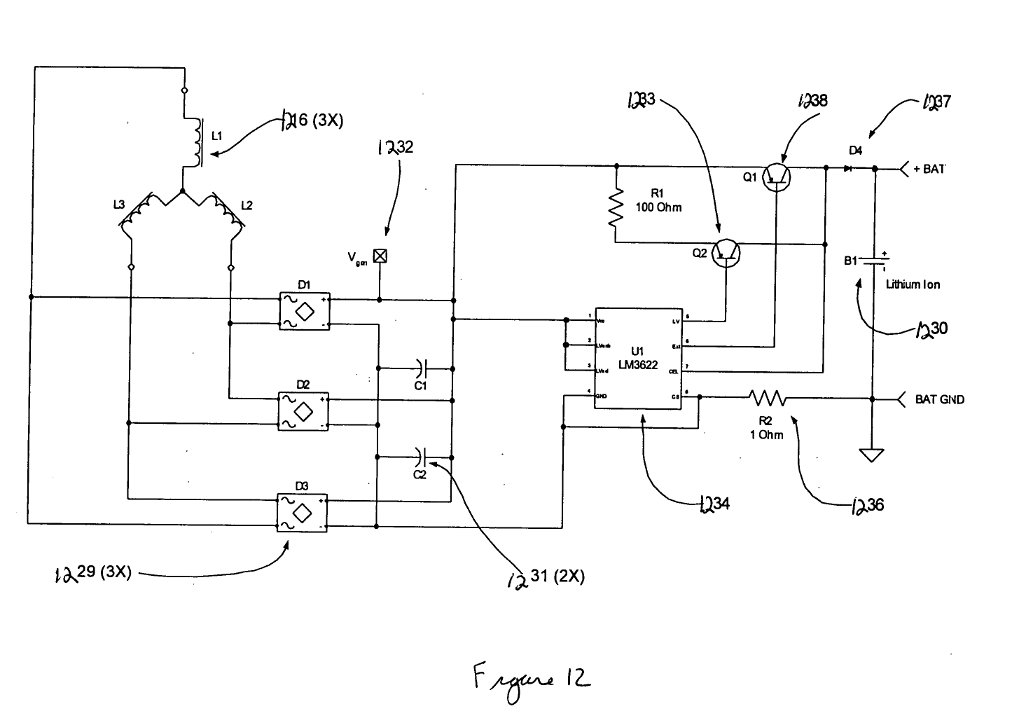

Continuing with FIG. 10, the user interface 202 includes a number of keys for users input for the showerhead and adjustment. The M key 1026 may be used in the menu mode; the up key 1027 and down key 1025 may be used to advance the menu choice or adjust the value presently displayed by a flashing (4) seven-segment digits.

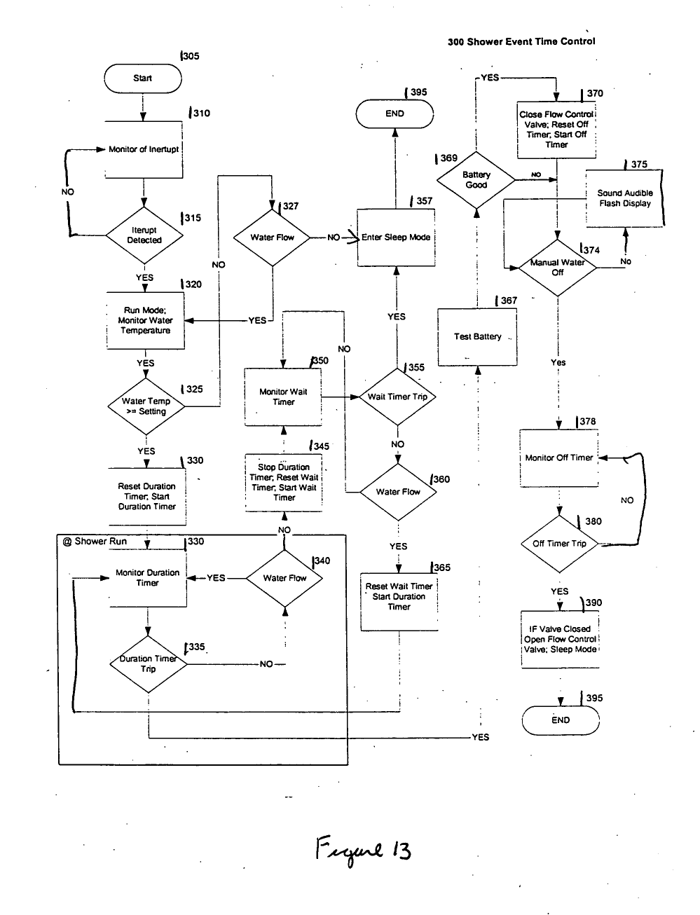

FIG. 11 illustrates with greater details the icon based user interface 202 that may be available for the shower head 100. The shower head 100 may have an icon based LCD module that provides comprehensive user information. What FIG. 11 shows and what is described are possibilities for the showerhead 100. FIG. 11 shows possible icon and usages. The icons include a clock mode indicator 1100, security lock indication 1102, a separate segment 1101 showing locked and unlocked, seven segment digits 1103 with a colon segment separating digits 2 and 3 and a decimal segment separating the least significant digit and second to least significant digit, multi-segment section 1104 indicating the day of the week, and other units referring to the current value which is depicted (4) seven-segment digits 1103, segment thermometer 1105, multiple water drop icon segment 1106, that depend on the amount activated to provide some feedback regarding the shower remaining duration, segment for showerhead icon 1107, when viewable, indicates active shower mode, segment 1109 that indicates active timing of duration or reset timer, segment 1108 and 1110 for the indication of timing to off “O”, segment 108 for an indication of timing to reset ‘I’, multi-segment battery icon 1111 provides an indication of present charge level of battery and addition segment 1112 for other units (degree F., degree C., a.m., p.m. or 24 HR) being associated with the value of the (4) seven-segment digits 1103.

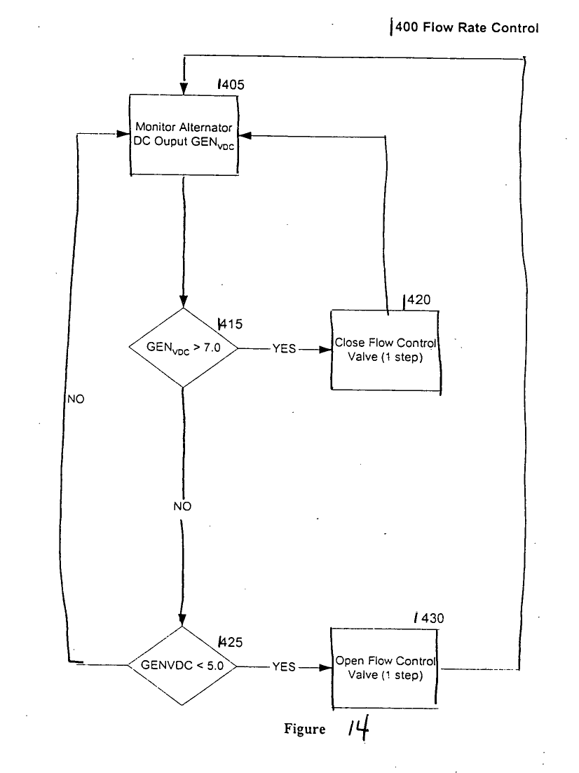

Referring to FIG. 12, the shower head 100 includes a battery charge controller 1234 which includes three charging modes. During the initial low battery voltage charging, a low current source is limited by resistor 1239 and provided to battery 1217 by transistor 1233. After this initial low battery voltage, charging continues at a higher current and is controlled by transistor 1238 in the constant current mode. The last mode is a constant voltage mode again controlled by transistor 1238. The slinger 702 as shown in FIG. 7 includes an even multiple of permanent magnets 704 that are rotated about the centerline axis of the slinger 702 as a result of the torque created by the tangential thrust of water exiting the perimeter of the slinger 702. The magnets 704 are arranged in an alternating pole pattern in those adjacent magnets are of opposite polarity. The magnets 704 move past the inductors 906 to create alternating levels of magnetic flux within the inductors 906 and creates an electromotive force within the windings of the inductors 906 surrounding the core. This alternating EMF creates an alternating current that is subsequently rectified to direct current by bridge rectifiers 1229. The voltage output at node 1232 from the rectifier circuit 1229 is monitored by the analog input of the microcontroller 1805. Capacitors 1231 reduce the DC ripple of the power supplied to the battery charge controller 1234.

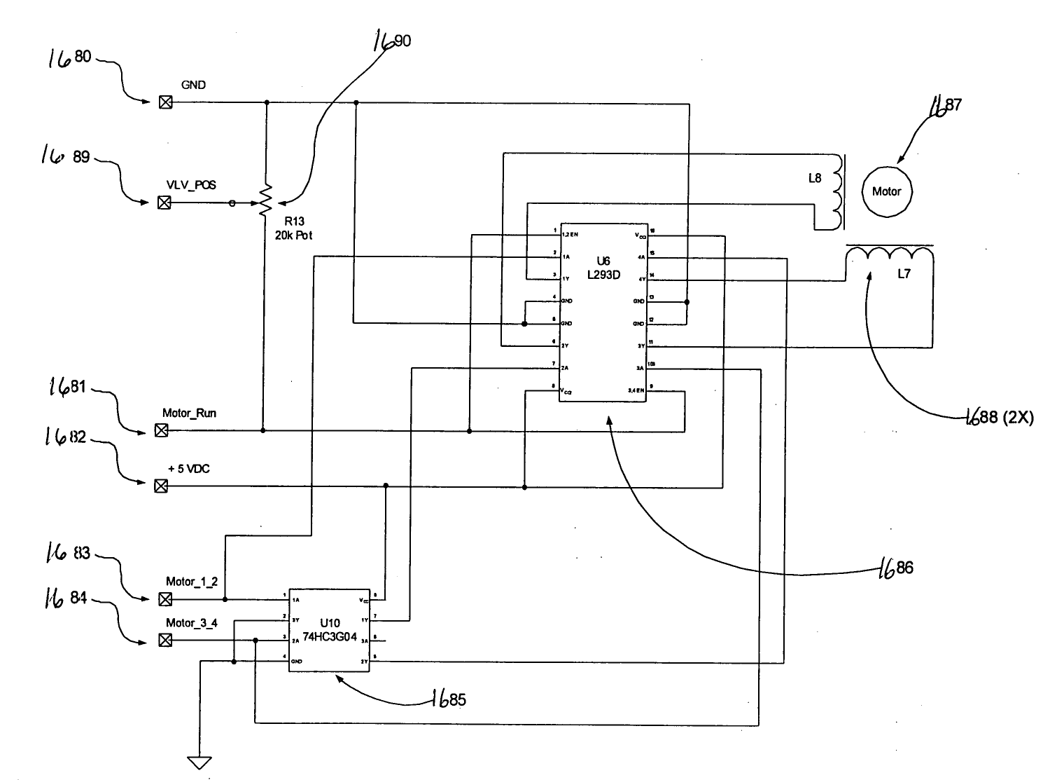

FIG. 15 illustrates the two power supplies for the shower head motor and the LCD. The logic circuits, the motor and the LCD are powered by, for example a 5 V, switching regulator 1541. During operation, an N channel MOSFET within the regulator 1541 is turned off and is turned on. When the N-channel MOSFET is on, current builds in the inductor 906. When the N-channel MOSFET is turned off, the energy stored during the on portion of the cycle is released; the voltage across the inductor 906 is reversed, and the current flows from the inductor 906 through diode 1542 to the storage capacitor 1544 and load. The output voltage and the control reference voltage are established by the voltage divider circuit between, in this example, +5 V and ground.

As shown in FIG. 15, the bias voltage for the LCD is provided by a separate inverting switching power supply 1548. The −14 V DC in this example used for the LCD bias voltage is produced by a push pull configuration of inductors 1547 and 1549. Both inductors 1547 and 1549 store energy during the on portion of the cycle and release energy during the off portion of the cycle. A voltage divider circuit is used to set the output voltage and is used as a control reference.

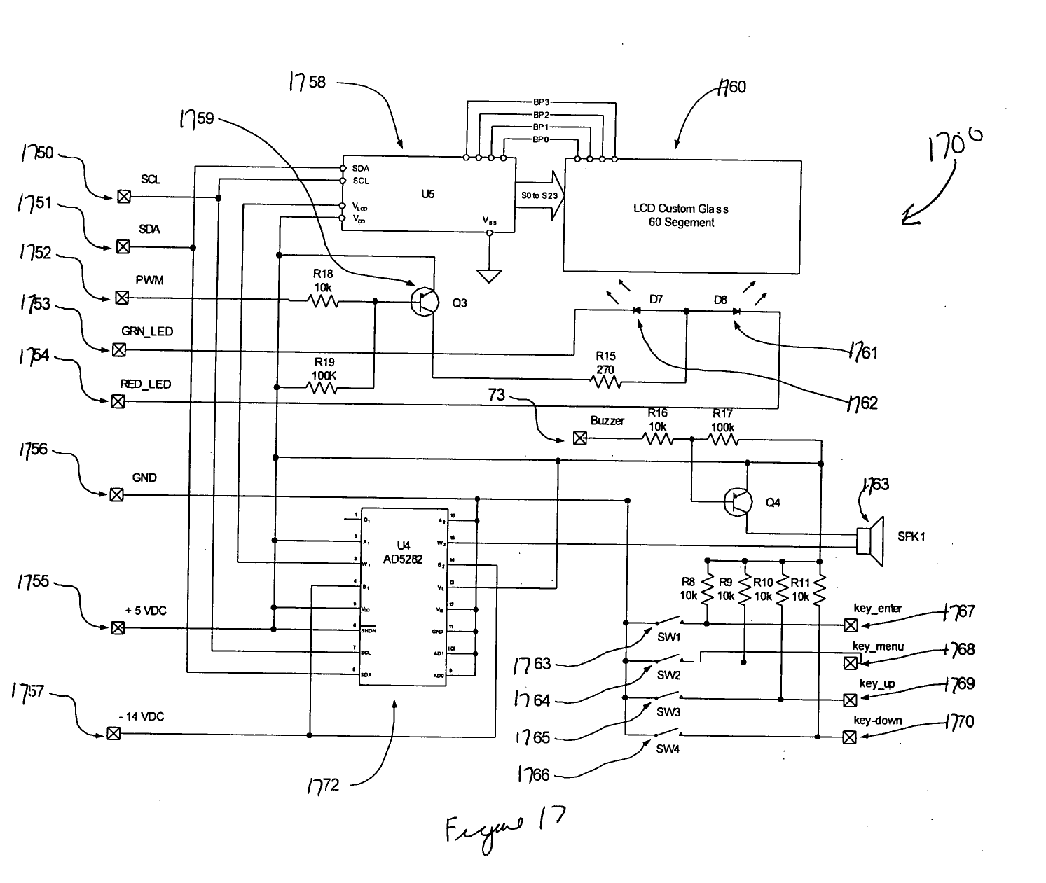

With reference to FIG. 16, the shower head flow control valve 204 is precisely positioned by use of a bipolar stepper motor 1647. The motor 1647 includes two electrical winding 1688 (L8 and L7) which are controlled by a quad half H-bridge driver 1686. The motor direction which could be either open or close is established by sequencing the motor lines motor_1_2 and motor_3_4 along with providing a step enable pulse after correct sequencing is established on the motor run line. Typically, the step duration pulse would be about 5 ms or other appropriate time. The quad half H-bridge driver 1686 includes two paired inputs with the discrete input of pairs which are the inverse of one another. Thus, two motor control lines are connected to the four discrete inputs of the quad half H-bridge 1686 by using inverter gate 1685. Each input pair is controlled by a single motor control line, with one input using a single inverter gate and the other input directly from the microcontroller output. FIG. 16 shows a bipolar stepper motor; however, other types of motors such as PWM motor control with reversible BDC motor or uni-polar stepper motors. Other types of motor control are possible.

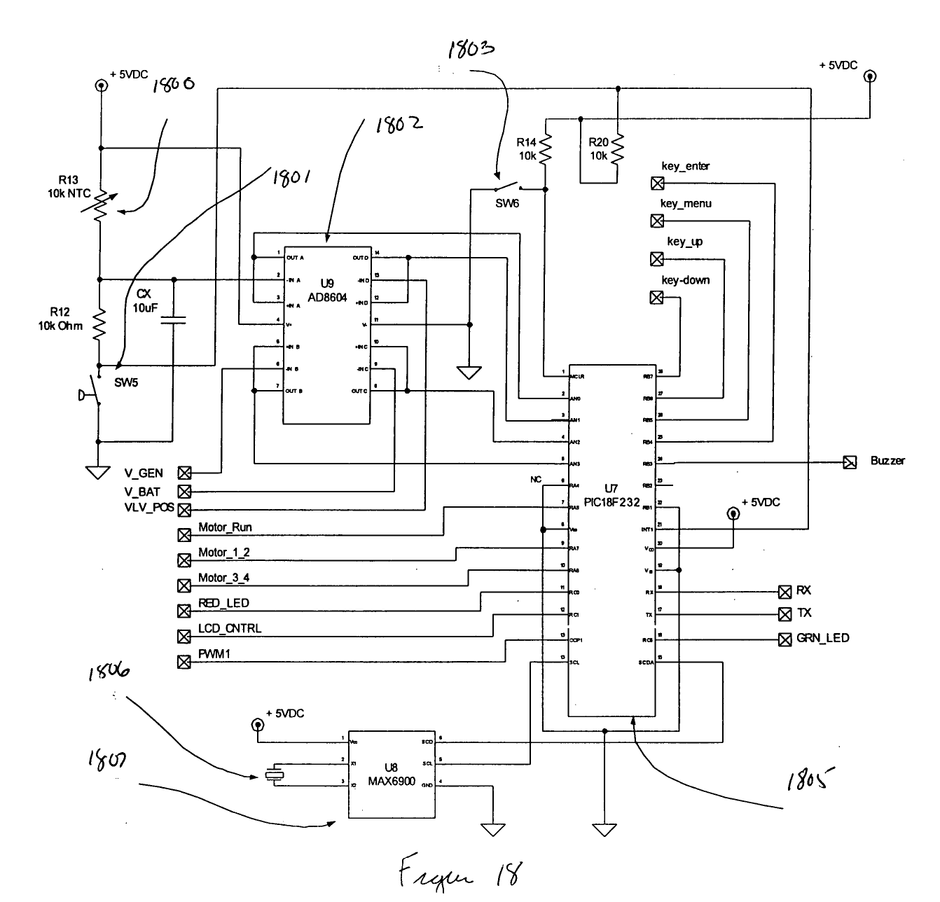

FIG. 17 illustrates the circuitry of an interface for the user. The shower head 100 includes operator interface circuitry 1700 that includes a LCD display 1760, audible device 1763, LED 1761, LCD 1762, enter key 1763, menu key 1764, increment key 1765 and decrement key 1766 being shown as switches. The segments of the LCD 1760 are controlled by the LCD driver 1758. The driver 1758 is interfaced to microcontroller 1805 by an I2C serial interface. The I2C serial interface includes a clock connection 1750 and a data connection 1751. Other types of interfaces could be used including but are limited to SPI discrete data lines with clock and other suitable interfaces. The multi-segment LCD 1760 is backlit by two different LED, red 1761 and green 1762 in this example. The particular LED to be used for backlighting is under the control of the microcontroller 1805 and is selected by the operating logic included within the memory of the microcontroller 1805. The intensity of the selected LED, green or red, is controlled by the PWM of PNP transistor 1759. The gate of transistors 1759 is under PWM control of the microcontroller 1805. This feature is used to give the appearance of brighter backlighting while consuming less electrical power.

The contrast of the multi-segment LCD 1760 may be adjusted to meet thermal compensation requirements or user preferences. This is accomplished by adjusting the bias voltage to the LCD driver 1758 by means of the I2C digital potentiometer 1772.

The pies electric buzzer 1763 is under control of the PNP transistor 1774. When the audible output is needed at the gate of transistors 1774 being turned on by the microcontroller 1805, the I2C digital potentiometer 1772 adjusts the drive voltage available to the buzzer 1763 as required for the desired sound pressure output.

FIG. 17 illustrates the operator interface 1700 and shows several keys to allow the viewing and adjustment of various parameters associated with the shower head 100. The keys include switches that are normally open with weak pull up resistors. These resistors pull the input voltage high on the microcontroller 1805 input pins when the switch is open state. The input to the switches is tied to logic ground with the output connected to and monitored by the general-purpose input pins of the microcontroller 1805. When the user places physical pressure against the switch, the output and input of the switch become shorted together, pulling the voltage low on the input pin of the microcontroller 1805. The outputs of the switches are also connected in parallel to an OR gate.

The multi-segment LCD display 1760 is controlled by I2C LCD driver 1758. The I2C LCD driver 1758 interfaces to the microcontroller 1805 via a serial communication bus that includes a data line and a clock line. Additionally, a dual digital potentiometer 1772 provides the variable bias voltage and variable voltage for the piezo electric buzzer. These devices share an I2C common bus with other peripheral real-time clocks and LCD driver.

FIG. 18 illustrates that the functionality of the shower head 100 is controlled by microcontroller 1805. The microcontroller 1805 is supported by peripheral I/Cs connected to various I/O pins. The op amp 1802 applies the necessary gain to the various analog signals, for example water temperature, valve position, battery voltage and alternator voltage, and offers a low impedance source for the same various analog input pins of the microcontroller 1805. The real-time clock 1807 is connected to the microcontroller 1805 via I2C interface. The purpose of the real-time clock is to allow accurate timekeeping while the microcontroller 1805 is in the sleep mode.

The microcontroller 1805 includes output pins to control the motor steps, buzzer activation, LED backlight PWM, LCD backlight red, LCD back light green and 14V enable.

While the present invention has been described in terms of specific embodiments, modifications to the above described features are considered to be within the scope of the present invention as defined by the claims.

1) A shower head for controlling the flow of water to a user, comprising:
an inlet for allowing said water to enter the shower head;
a microcontroller to control the time duration of the flow of said water;
a valve to shut off said water after said time duration.

2) A shower head for controlling the flow of water to a user as in claim 1, wherein said microcontroller is operable to provide a warning to said user at a predetermined time before said water is shut off.

3) A shower head for controlling the flow of water to a user as in claim 1, wherein said microcontroller is operable to control said valve at a predetermined level.

4) A shower head for controlling the flow of water to a user as in claim 3 wherein said valve is controlled by a motor under pulse width modulation.

5) A shower head for controlling the flow of water to a user as in claim 3 wherein said valve is controlled by a stepper motor.

6) A shower head for controlling the flow of water to a user as in claim 1 wherein said microcontroller can detect that the flow of said water has been ended by action of the user and said microcontroller enters a wait state.

7) A shower head for controlling the flow of water to a user as in claim 1, wherein said shower head includes a generator to generate electrical power.

8) A shower head for controlling the flow of water to a user as in claim 2, wherein said warning is an audible warning.

9) A shower head for controlling the flow of water to a user as in claim 2, wherein said warning is a visual warning.

10) A shower head for controlling the flow of water to a user as in claim 2, wherein said warning is both an audible warning and a visual warning.

11) A shower head for controlling the flow of water to a user as in claim 1, wherein said shower head includes a user interface to allow the user to change a parameter of said shower head.

12) A shower head for controlling the flow of water to a user as in claim 11, wherein said user interface allows entry of a security code to permit said change in said parameters of said shower head.

13) A shower head for controlling the flow of water to a user as in claim 1, wherein said microprocessor is operable to monitor the temperature of said water.

14) A shower head for controlling the flow of water to a user as in claim 13, wherein said microprocessor delays said time duration until a predetermined temperature has been reached.

15) A shower head for controlling the flow of water to a user as in claim 13, wherein said microprocessor is operable to warn said user if said temperature of said water reaches an unsafe level.

16) A shower head for controlling the flow of water to a user as in claim 13, wherein said unsafe level is adjustable by said user.

17) A shower head for controlling the flow of water to a user as in claim 11, wherein said user interface includes an indicator of the elapsed time duration.

18) A shower head for controlling the flow of water to a user as in claim 3, wherein said microcontroller performs a determination of battery charge level prior to operation of said valve.

19) A shower head for controlling the flow of water to a user as in claim 1, wherein said microcontroller operates in multi-voltage levels.

20) A shower head for controlling the flow of water to a user as in claim 1, wherein said user interface includes an indicator having at least one of real date and time of day information.
